(19) United States
(12) Patent Application Publication
(10) Pub. No.: US 2015/0109974 A1
(43) Pub. Date: Apr. 23, 2015

(54) System and Method for Reference Signal Transmission to Avoid Collision

(71) Applicants: Erlin Zeng, Beijing (CN); Asbjoern Groevlen, Frederiksberg (DK)

(72) Inventors: Erlin Zeng, Beijing (CN); Asbjoern Groevlen, Frederiksberg (DK)

(73) Assignee: Broadcom Corporation, Irvine, CA (US)

(21) Appl. No.: 14/400,501

(22) PCT Filed: May 11, 2012
(86) PCT No.: PCT/CN2012/075389

§ 371 Date: Nov. 11, 2014

(51) Int. Cl. H04L 5/00; H04W 48/16; H04W 56/00; H04L 5/14

(52) U.S. Cl. CPC H04L 5/0048; H04L 5/14; H04W 48/16; H04W 56/0005
USPC 370/280; 370/336; 370/281

(57) ABSTRACT

A method of wireless communications for use with user equipment, comprising identifying a subframe in a radio frame in which a synchronizing signal is to be transmitted, and transmitting a reference signal to the user equipment in a subframe other than the identified subframe.

### FIELD

The present disclosure relates the field of wireless communications, and more particularly to a system and method for reference signal transmission to avoid collision with synchronization signals.

### BACKGROUND

Wireless communication networks are widely deployed to provide various communication services such as voice, video, packet data, messaging, broadcast, etc. These wireless networks may be multiple-access networks capable of supporting multiple users by sharing the available network resources. A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station. The Third Generation Partnership Project (3GPP) unites six telecommunications standards bodies, known as “Organizational Partners,” and provides their members with a stable environment to produce the highly successful Reports and Specifications that define 3GPP technologies, including WCDMA (Wideband Code Division Multiple Access). These technologies are constantly evolving through what have become known as “generations” of commercial cellular/mobile systems. 3GPP also uses a system of parallel “releases” to provide developers with a stable platform for implementation and to allow for the addition of new features required by the market. Each release includes specific functionality and features that are specified in detail by the version of the 3GPP standards associated with that release.

Universal Mobile Telecommunication System (UMTS) is an umbrella term for the third generation (3G) radio technologies developed within 3GPP and initially standardized in Release 99. UMTS includes specifications for both the UMTS Terrestrial Radio Access Network (UTRAN) as well as the Core Network. The UTRAN includes at least one Radio Network Subsystem (RNS), which in turn includes a single Radio Network Controller (RNC) that controls at least one base station also known as Node B.

Currently there is an on-going Work Item “LTE Carrier Aggregation Enhancement” for 3GPP Release 11. The present disclosure is related to an open issue on new carrier type design for Release 11.

### SUMMARY

A method of wireless communications for use with user equipment comprises identifying a subframe in a radio frame in which a synchronizing signal is to be transmitted, and transmitting a reference signal to the user equipment in a subframe other than the identified subframe.

A wireless communication network element in communication with user equipment comprises means for transmitting and receiving wireless signals, processor means, and a memory for storing program code that, when executed by the processor, causes the wireless communication device to perform: identifying a subframe in a radio frame in which a synchronizing signal is to be transmitted, and transmitting a reference signal to the user equipment in a subframe other than the identified subframe.

A computer-readable medium having encoded thereon instructions that cause a wireless communication network element to perform identifying a subframe in a radio frame in which a synchronizing signal is to be transmitted, and transmitting a reference signal to the user equipment in a subframe other than the identified subframe.

### BRIEF DESCRIPTION OF THE DRAWINGS

FIG. 1 is a simplified block diagram of a wireless network structure of UMTS (Universal Mobile Telecommunications System) 10;

FIG. 2 is a diagram of a downlink FDD frame structure 30;

FIG. 3 is a diagram of further details of a subframe of a radio frame; and

FIG. 4 is a diagram of an exemplary reference signal pattern for CRS port #0;

FIG. 5 shows the locations of the PSS and SSS transmissions in addition to the reference signal patterns for port #0 and port #7 and #8, according to the current LTE standards specification;

FIGS. 6a and 6b are diagrams showing PSS/SSS time location proposed for FDD with normal CP;

FIGS. 7-11 show exemplary PSS/SSS locations with CRS time restriction according to an embodiment of the present disclosure;

FIG. 12 is a flowchart of an exemplary method 50 according to an embodiment of the present disclosure; and

FIG. 13 is a simplified block diagram of an exemplary WTRU 70 or User Equipment configured or arranged to receive DM RS and PSS/SSS as described above.

### DETAILED DESCRIPTION

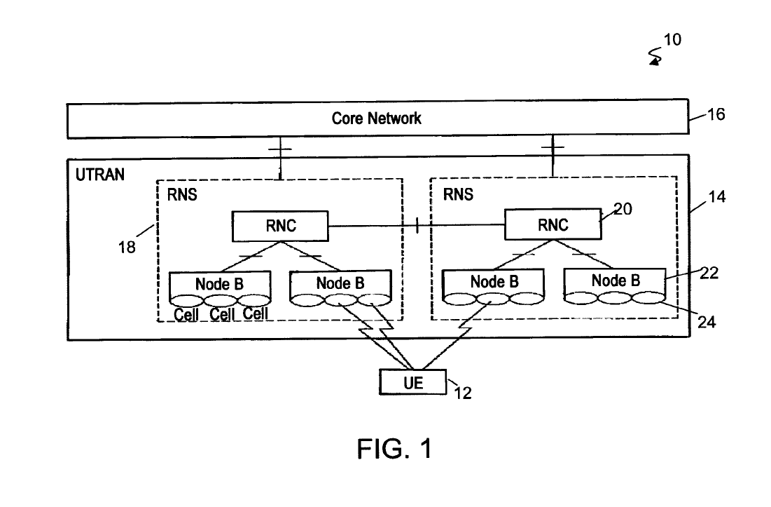

FIG. 1 is a simplified block diagram of a wireless network structure of UMTS (Universal Mobile Telecommunications System) 10. A UMTS or wireless network 10 includes at least one user equipment (User Equipment) 12, a UMTS radio access network (UTRAN) 14 and a core network (CN) 16. The UTRAN includes at least one or more radio network subsystems (RNS) 18. Each RNS 18 includes a single radio network controller (RNC) 20 and at least one base station (Node B) 22. The RNC 20 manages the at least one base station 22. Each base station 22 includes one or more cells 24. In the protocol documents of the standardization organization 3GPP of the UMTS, there are TS25.2XX, TS25.3XX and other specifications relevant to the UMTS radio interface protocol.

The uplink transmission channels that may be utilized by a User Equipment 12 include RACH (Random Access Channel), E-DCH (Enhanced Dedicated Channel) and the like, and downlink transmission channels comprise BCH (Broadcast Channel), PCH (Paging Channel), FACH (Forward Access Channel), DSCH (Downlink Shared Channel), HS-DSCH (High Speed Downlink Shared Channel), DCH and the like. The uplink and downlink transmission channels for carrying user data include RACH/FACH, DCH/DCH, DCH/(DCH+DSCH), DCH/HS-DSCH, DCH/(DCH+HS-DSCH), E-DCH/DCH, E-DCH/HS-DSCH, and E-DCH/(DCH+HS-DSCH). Uplink physical channels include PRACH (Physical Random Access Channel), PCPCH (Physical Common Packet Channel), uplink DPCCH (Dedicated Physical Control Channel), uplink DPDCH (Dedicated Physical Data Channel), E-DPCCH (Enhanced Dedicated Physical Control Channel), E-DPDCH (Enhanced Dedicated Physical Data Channel), and the like, downlink physical channels include P-CCPCH (Primary Common Control Physical Channel), S-CCPCH (Secondary Common Control Physical Channel), PDSCH (Physical Downlink Shared Channel), downlink DPCCH, downlink DPDCH, HS-DPCCH (High Speed Dedicated Control Channel), HS-PDSCH (High Speed Physical Downlink Shared Channel), and the like, and these physical channels have the corresponding relationships with the transmission channels, wherein the DPCH (Dedicated Physical Channel) is a general term of DPCCH/DPDCH. Further, the downlink includes SCH (Synchronization Channel), CPICH (Common Pilot Channel), AICH (Acquisition Indicator Channel), PICH (Paging Indication Channel), F-DPCH (Fractional Dedicated Physical Channel), HS-SCCH (High Speed Shared Control Channel), AGCH (Absolute Grant Channel), RGCH (Relative Grant Channel), and the like, all of which are part of the physical layer.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, or the like. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth.

In one aspect of the present disclosure, the wireless network 10 may support Frequency Division Duplex (FDD) or Time Division Duplex (TDD) modes of operation. The techniques described herein may be used for FDD or TDD mode of operation.

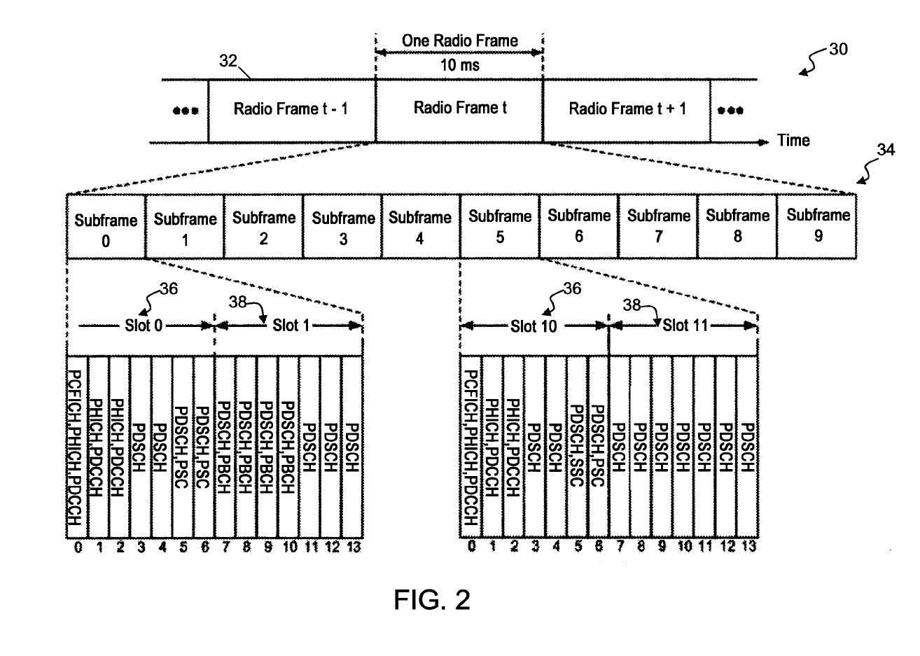

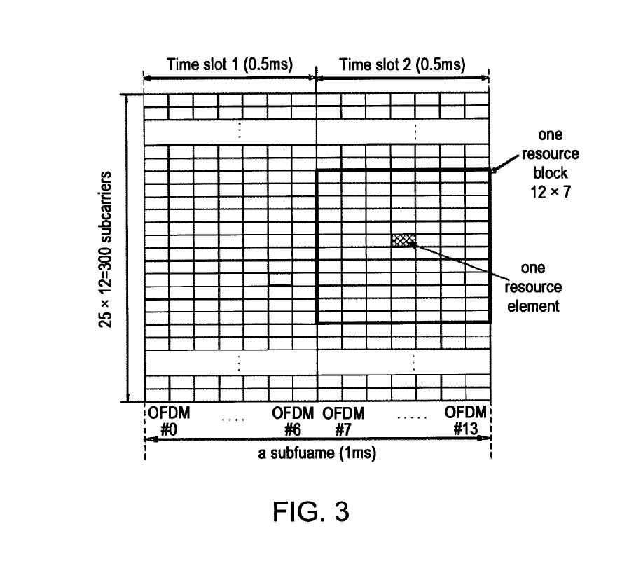

FIG. 2 shows a downlink FDD frame structure 30 used in LTE. The transmission timeline for the downlink may be partitioned into units of radio frames 32. Each radio frame 32 may have a predetermined duration (e.g., 10 milliseconds (ms)) and may be partitioned into 10 subframes 34 with indices 0 through 9. Each subframe 34 may include two slots 36 and 38. Each radio frame 32 may thus include 20 slots with indices of 0 through 19. Each slot may include L symbol periods, e.g., 7 symbol periods for a normal cyclic prefix (CP or NCP) (as shown in FIG. 2) or 6 symbol periods for an extended cyclic prefix (ECP). The 2L symbol periods in each subframe 34 may be assigned indices of 0 through 2L-1. The available time frequency resources may be partitioned into Physical Resource Blocks (PRB) 40, shown in FIG. 3. Each resource block 40 may cover N subcarriers (e.g., 12 subcarriers) in one slot.

In LTE, an eNodeB may send a primary synchronization signal (PSC or PSS) and a secondary synchronization signal (SSC or SSS) for each cell in the eNodeB. If a UE is first powered on or enters a new cell, it performs initial cell search such as synchronization with a BS. For the initial cell search, the UE receives a PSS and an SSS from the BS, establishes synchronization with the BS, and obtains information such as a cell identity (ID). Generally, the PSS is used to obtain time-domain synchronization, such as OFDM symbol synchronization and slot synchronization, and/or frequency synchronization. The SSS is used to obtain frame synchronization, a cell identifier (cell ID), and/or CP configuration of a cell (i.e. information as to whether a normal CP is used or an extended CP is used). The PSS and the SSS are transmitted through two OFDM symbols in every radio frame. A subframe in which a synchronization signal (e.g., PSS and/or SSS) is transmitted is referred to as a synchronization signal subframe or a PSS/SSS subframe. For FDD mode of operation, the primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. For FDD mode of operation, the eNodeB may send a Physical Broadcast Channel (PBCH) in symbol periods 0 to 3 in slot 1 of subframe 0. The PBCH may carry certain system information.

A Resource Element (RE) is a subcarrier on an OFDM symbol, 12 contiguous subcarriers and 7 contiguous OFDM symbols constitute a downlink Resource Block (RB) or Physical Resource Block (PRB) which is 180 kHz in the frequency domain and has a time length of a normal time slot in a time domain, as shown in FIG. 3. When the LTE system performs resource allocation, a Resource Block is a basic unit for allocation. Wherein when an extended cyclic prefix is adopted, the number of contiguous OFDM symbols comprising an RB is 6. While a subframe is shown in FIG. 3 as having a slot with 7 OFDM symbols for illustrative purposes, embodiments of the present invention are also applicable to subframes with any other number of OFDM symbols. Each element in the resource grid for an antenna port is called Resource Element (RE). Each RE is formed by one OFDM symbol by one subcarrier. An RE is also referred to as a tone.

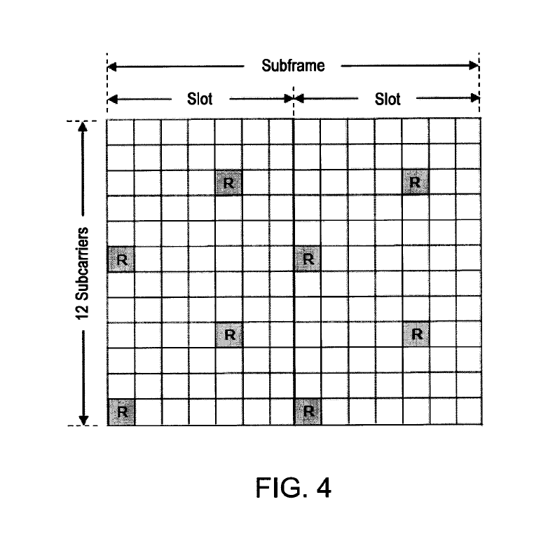

Reference signals are generated as the product of an orthogonal sequence and a pseudo-random numerical (PRN) sequence. Overall, there are 510 possible unique reference signals. A specified reference signal is assigned to each cell within a network and acts as a cell-specific identifier. The LTE system supports the MIMO (multiple-input and multiple-output) application of multiple antennae for receiving and transmitting signals, and the corresponding antenna port #0, antenna port #1, antenna port #2 and antenna port #3, etc. adopt a method of full bandwidth Cell-Specific Reference Signals (CRS). Reference signals are transmitted on equally spaced subcarriers within the first and third from last OFDM symbol of each slot. When a reference signal is transmitted from one antenna port, the other antenna ports in the cell are idle. One example of Release 10 CRS pattern for port #0 is shown in FIG. 4, which includes DM RS resource elements in the last and the second to the last OFDM symbol in the first slot.

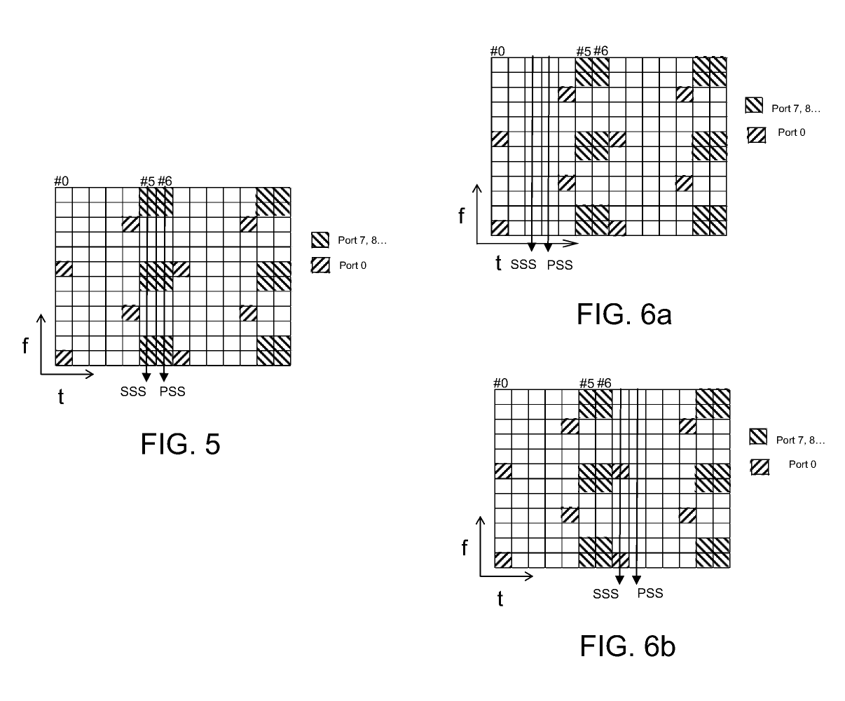

FIG. 5 shows the locations of the PSS and SSS transmissions in addition to the reference signal patterns for port #0 and port #7 and #8, according to the current LTE standards specification. The PSS and SSS, for FDD with normal CP, are mapped to the mid-6 PRB of the last and second to the last OFDM symbol in the first slot in subframes #0 and #5 in each radio frame. It may be seen that such mapping results in collisions between PSS/SSS and DM RS.

In LTE Release 10, the solution for avoiding PSS/SSS and DM RS collision is to restrict where DM RS is scheduled to avoid PRBs that contain PSS/SSS transmissions.

A solution has also been proposed in R1-121617, Synchronization Signal Mapping For the New Carrier Type, submitted to the working group WG1 at a meeting that took place on Mar. 26-30, 2012. As shown in FIGS. 6a and 6b, new PSS/SSS time location was proposed in R1-121617 for FDD with normal CP. This solution moves the PSS/SSS signals to other OFDM symbols that do not contain any DM RS. However, this proposed scheme cannot be used where ECP is configured, or in a TDD system where PSS is mapped to special subframes that contain a special field, DwPTS (Downlink Pilot Time Slot). Under this scheme, there are not two available adjacent symbols for the transmission of PSS and SSS in the special subframe with DwPTS length of 9 or 10. Further, possible mappings to non-adjacent symbols results in the PSS and SSS too far apart at 5 symbols, which leads to unacceptable synchronization performance.

The present disclosure is directed a method of introducing a restriction to the time domain resources of CRS port #0, so that CRS port #0 is not transmitted in the subframes that contain PSS or SSS. For example, for TDD, CRS port #0 is not transmitted in DwPTS in a special subframe, nor in subframe #6 if it is a normal downlink subframe. Accordingly, PSS and SSS are moved to OFDM symbols which do not contain DM RS or CRS resource elements. The time distance between PSS and SS is minimized for coherent SSS detection. Therefore, for example, for TDD, CRS port #0 is not transmitted in special subframe #1 and #6 in a radio frame, and for FDD, CRS port #0 is not transmitted in subframe #0 and #5 in a radio frame.

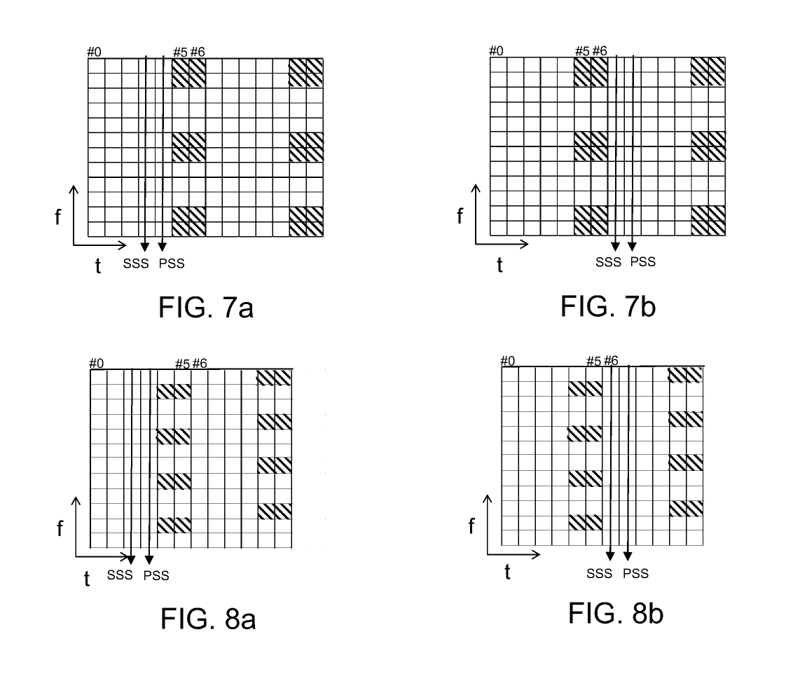

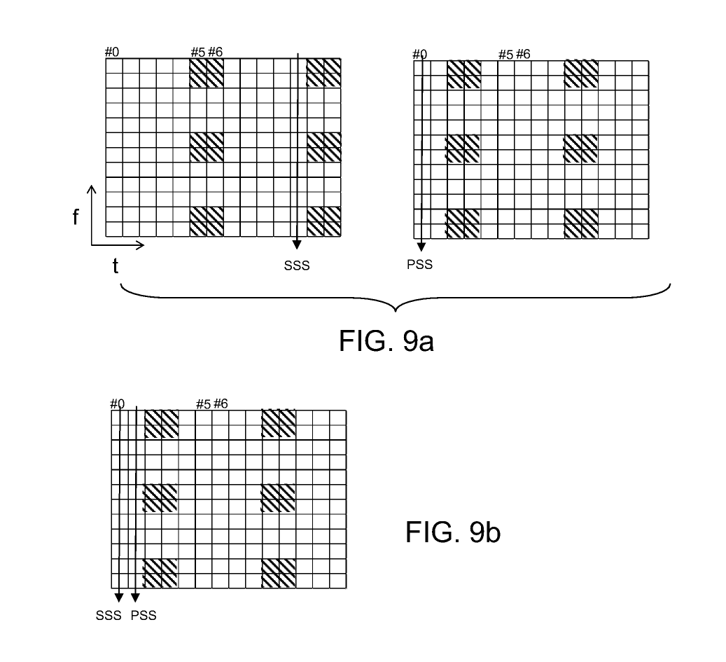

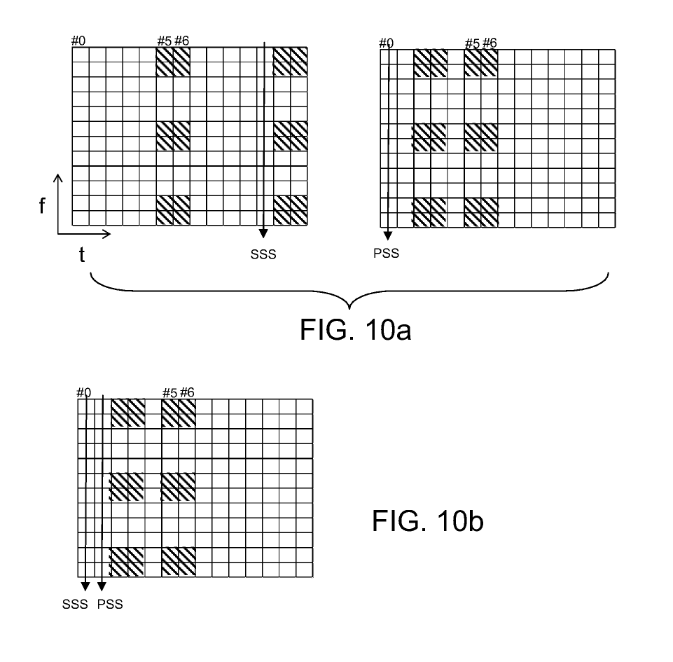

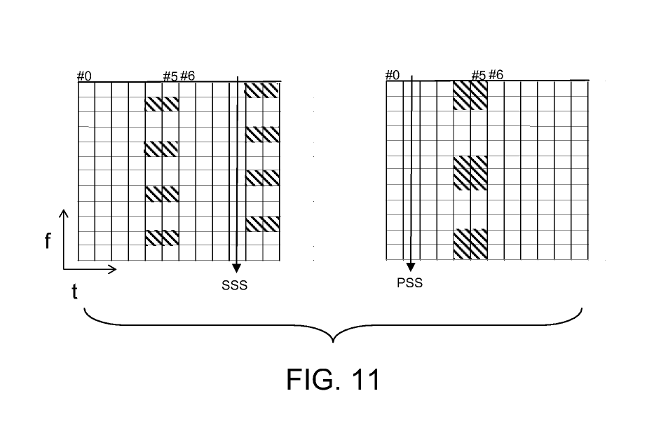

FIGS. 7-11 show exemplary PSS/SSS locations with CRS time restriction according to an embodiment of the present disclosure. FIGS. 7a and 7b provide two exemplary patterns for the case of FDD with normal CP. FIGS. 8a and 8b provide two exemplary patterns for the case of FDD with extended CP. FIGS. 9a and 9b provide two exemplary patterns for the case of TDD with normal CP, with a DwPTS length of 11 or 12. In FIG. 9a, the time gap between PSS and SSS is three symbols, which is the same as Release 8 TDD. In FIG. 9b, PSS and SSS occupy adjacent symbols, which is the same as Release 8 FDD. FIGS. 10a and 10b provide two exemplary patterns for the case of TDD with normal CP, with a DwPTS length of 9 or 10. In FIG. 10a, the time gap between PSS and SSS is three symbols, which is the same as Release 8 TDD. FIG. 11 is an exemplary pattern for the case of TDD with extended CP, with DwPTS length of 8, 9, or 10.

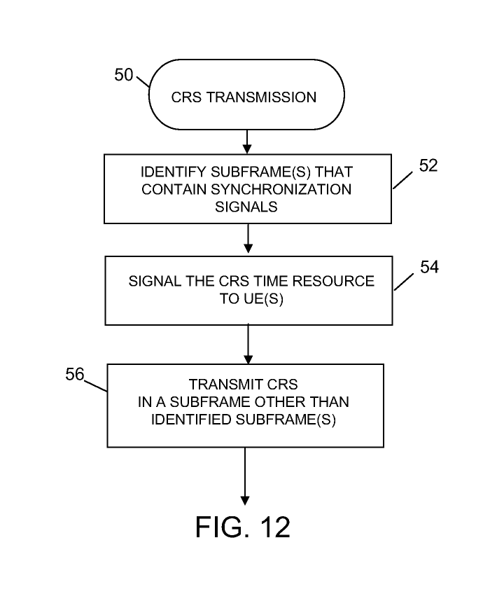

FIG. 12 is a flowchart of an exemplary method 50 according to an embodiment of the present disclosure. In step 52, a determination is made to identify those subframe(s) that contain a synchronization signal including, e.g., PSS, SSS, and DwPTS. In block 54, the CRS time resources are signalled to the User Equipment. This information may be transmitted via broadcast signalling or UE-specific signalling. Alternatively, the subframes can be predefined so that no signalling is needed. In block 56, the CRS is transmitted in a subframe other than identified subframes that contain the synchronization signals to avoid collision. For example, for TDD, CRS port #0 is not transmitted in special subframe #1 and #6 in a radio frame; and for FDD, CRS port #0 is not transmitted in subframe #0 and #5 in a radio frame.

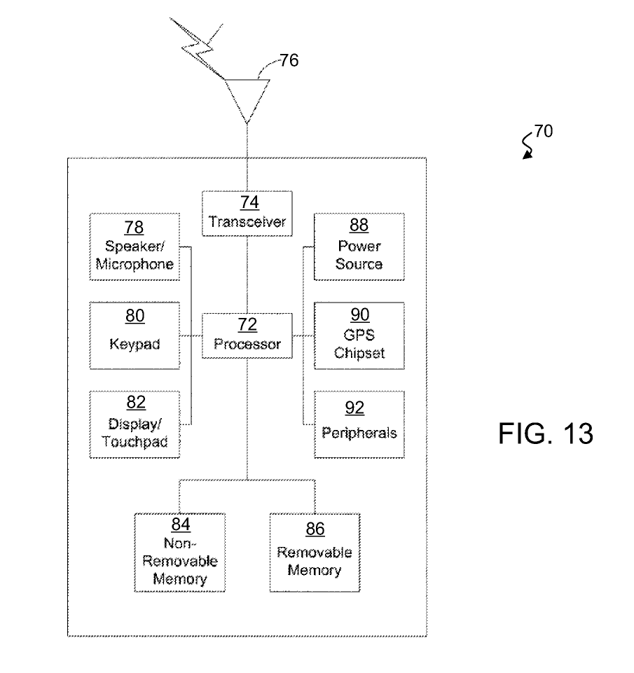

FIG. 13 is a simplified block diagram of an exemplary WTRU 70 or User Equipment configured or arranged to receive CRS and PSS/SSS as described above. The WTRU 70 includes a processor 72, a transceiver 74, a transmit/receive element 76, and may further include a speaker/microphone 78, a keypad 80, a display/touchpad 82, non-removable memory 84, removable memory 86, a power source 88, a global positioning system (GPS) chipset 90, and other peripherals 92.

The processor 72 may be a general purpose processor, a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 72 may perform signal coding, data processing, power control, input/output processing, and/or any other functionality that enables the WTRU 70 to operate in a wireless environment. The processor 72 may be coupled to the transceiver 74, which may be coupled to the transmit/receive element 76. While FIG. 4 depicts the processor 72 and the transceiver 74 as separate components, it should be appreciated that the processor 72 and the transceiver 74 may be integrated together in an electronic package or chip.

The transmit/receive element 76 is configured to transmit signals to, or receive signals from, a base station over the air interface. For example, in one embodiment, the transmit/receive element 76 may be an antenna configured to transmit and/or receive RF (radio frequency) signals. In another embodiment, the transmit/receive element 76 may be an emitter/detector configured to transmit and/or receive IR (infrared), UV (ultra-violet), visible light signals, and/or a combination thereof. It will be appreciated that the transmit/receive element 76 may be configured to transmit and/or receive any combination of wireless signals. In addition, although the transmit/receive element 76 is depicted in FIG. 4 as a single element, the WTRU 70 may include any number of transmit/receive elements 76. More specifically, the WTRU 70 may employ MIMO (multiple input multiple output) technology. Thus, in one embodiment, the WTRU 70 may include two or more transmit/receive elements 76 (e.g., multiple antennas) for transmitting and receiving wireless signals over the air interface. The transceiver 74 may be configured to modulate the signals that are to be transmitted by the transmit/receive element 76 and to demodulate the signals that are received by the transmit/receive element 76. As noted above, the WTRU 70 may have multi-mode capabilities. Thus, the transceiver 74 may include multiple transceivers for enabling the WTRU 70 to communicate via multiple RATs, such as UTRA and IEEE 802.11 (commonly called WiFi), for example.

The processor 72 of the WTRU 70 may be coupled to, and may receive user input data from, the speaker/microphone 78, the keypad 80, and/or the display/touchpad 82 (e.g., a liquid crystal display (LCD) display unit or organic light-emitting diode (OLED) display unit). The processor 72 may also output user data to the speaker/microphone 78, the keypad 80, and/or the display/touchpad 82. In addition, the processor 72 may access information from, and store data in, any type of suitable memory, such as the non-removable memory 84 and/or the removable memory 86. The non-removable memory 84 may include random-access memory (RAM), read-only memory (ROM), a hard disk, or any other type of memory storage device. The removable memory 86 may include a subscriber identity module (SIM) card, a memory stick, a secure digital (SD) memory card, and the like. In other embodiments, the processor 72 may access information from, and store data in, memory that is not physically located on the WTRU 70, such as on a server or a home computer (not shown). The non-removable memory 84 and/or the removable memory 86 are configured to store a myriad types of data, including computer program instructions, control data, status data, and user data (e.g., text, images, video, audio, songs, emails, records, and files).

The processor 72 may receive power from the power source 88, and may be configured to distribute and/or control the power to the other components in the WTRU 70. The power source 88 may be any suitable device for powering the WTRU 70. For example, the power source 88 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 72 may also be coupled to the GPS chipset 90, which may be configured to provide location information (e.g., longitude, latitude, and altitude) regarding the current location of the WTRU 70. In addition to, or in lieu of, the information from the GPS chipset 90, the WTRU 70 may receive location information over the air interface from a base station and/or determine its location based on the timing of the signals being received from two or more nearby base stations. It will be appreciated that the WTRU 70 may acquire location information by way of any suitable location-determination method while remaining consistent with an embodiment. The processor 72 may further be coupled to other peripherals 92, which may include one or more software, firmware, and/or hardware modules that provide additional features, functionality and/or wired or wireless connectivity. For example, the peripherals 92 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

When referred to herein, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, a laptop, a portable device, or any other type of user device capable of transmitting and/or receiving wireless signals and operating in a wireless environment. When referred to herein, the terminology “base station” includes but is not limited to a Node-B, an evolved Node-B, a site controller, an access point (AP), or any other type of interfacing device capable of operating in a wireless environment.

The features of the present invention which are believed to be novel are set forth below with particularity in the appended claims. However, modifications, variations, and changes to the exemplary embodiments described above will be apparent to those skilled in the art, and the control system and method described herein thus encompass such modifications, variations, and changes and are not limited to the specific embodiments described herein.

1. A method of wireless communications for use with user equipment, comprising:
identifying at least one subframe in a radio frame in which a synchronizing signal is to be transmitted; and
transmitting a reference signal to the user equipment in a subframe other than the identified at least one subframe.

2. The method of claim 1, further comprising:
determining at least one subframe in which to transmit the reference signal in response to the identified at least one subframe of the synchronizing signal; and
informing the user equipment the at least one subframe in which to transmit the reference signal.

3. The method of claim 1, wherein identifying a subframe comprises identifying a subframe in which at least one of a primary synchronizing signal, secondary synchronizing signal, and downlink pilot time slot is to be transmitted.

4. The method of claim 1, wherein transmitting a reference signal comprises transmitting a cell-specific reference signal (CRS) port #0 to the user equipment in a subframe other than the identified subframe.

5. The method of claim 1, wherein transmitting a reference signal comprises not transmitting cell-specific reference signal (CRS) port #0 in special subframe #1 and subframe #6 in a radio frame for Time Division Duplex (TDD).

6. The method of claim 1, wherein transmitting a reference signal comprises not transmitting cell-specific reference signal (CRS) port #0 in subframe #0 and subframe #5 in a radio frame for Frequency Division Duplex (FDD).

7. A wireless communication device, comprising:
at least one transmit/receive element for transmitting and receiving wireless signals;
at least one processor; and
a memory storing program code that is executable by the at least processor,
wherein the memory with the program code is configured with the at least one processor to cause the wireless communication device to perform:
receiving identity of at least one subframe in a radio frame in which a synchronizing signal is to be received;
receiving a reference signal in a subframe other than the identified at least one subframe;
receiving a synchronizing signal; and
performing a cell search procedure using the received reference signal and synchronization signal.

8. The wireless communication device of claim 7, wherein the memory with the program code is configured with the at least one processor to further cause the wireless device to perform a cell search procedure using received primary synchronizing signal, secondary synchronizing signal, and cell specific reference signal.

9. The wireless communication device of claim 7, wherein the memory with the program code is configured with the at least one processor to further cause the wireless device to receive the reference signal in a subframe not containing a primary synchronizing signal, a secondary synchronizing signal, and a downlink pilot time slot.

10. The wireless communication device of claim 7, wherein the memory with the program code is configured with the at least one processor to further cause the wireless device to receive a cell-specific reference signal (CRS) port #0 in a subframe other than the identified subframe.

11. The wireless communication device of claim 7, wherein the memory with the program code is configured with the at least one processor to further cause the wireless device to receive cell-specific reference signal (CRS) port #0 in a subframe other than a special subframe #1 and subframe #6 in a radio frame for Time Division Duplex (TDD).

12. The wireless communication device of claim 7, wherein the memory with the program code is configured with the at least one processor to further cause the wireless device to receive cell-specific reference signal (CRS) port #0 in a subframe other than a subframe #0 and subframe #5 in a radio frame for Frequency Division Duplex (FDD).

13. A computer-readable memory having encoded thereon instructions that cause a wireless communication network element to perform:
identifying at least one subframe in a radio frame in which a synchronizing signal is to be transmitted; and
transmitting a reference signal to the user equipment in a subframe other than the identified at least one subframe.

14. The computer-readable memory of claim 13, wherein the wireless communication network element is further caused to perform;
determining at least one subframe in which to transmit the reference signal in response to the identified at least one subframe of the synchronizing signal; and
informing the user equipment the at least one subframe in which to transmit the reference signal.

15. The computer-readable memory of claim 13, wherein identifying a subframe comprises identifying a subframe in which at least one of a primary synchronizing signal, secondary synchronizing signal, and downlink pilot time slot is to be transmitted,

16. The computer-readable memory of claim 13, wherein transmitting a reference signal comprises transmitting a cell-specific reference signal (CRS) port #0 to the user equipment in a subframe other than the identified subframe.

17. The computer-readable memory of claim 13, wherein transmitting a reference signal comprises not transmitting cell-specific reference signal (CRS) port #0 in special subframe #1 in a radio frame for Time Division Duplex (TDD).

18. The computer-readable memory of claim 13, wherein transmitting a reference signal comprises not transmitting cell-specific reference signal (CRS) port #0 in subframe #6 in a radio frame for Time Division Duplex (TDD).

19. The computer-readable memory of claim 13, wherein transmitting a reference signal comprises not transmitting cell-specific reference signal (CRS) port #0 in subframe #0 in a radio frame for Frequency Division Duplex (FDD).

20. The computer-readable memory of claim 13, wherein transmitting a reference signal comprises not transmitting cell-specific reference signal (CRS) port #0 in subframe #5 in a radio frame for Frequency Division Duplex (FDD).
